(19) United States
(12) Patent Application Publication
(10) Pub. No.: US 2018/0320757 A1
(43) Pub. Date: Nov. 8, 2018

(54) GUIDE DEVICE FOR LONG OBJECT, AND GUIDE RAIL

(71) Applicant: TSUBAKIMOTO CHAIN CO., Osaka-shi, Osaka (JP)

(72) Inventor: Takayuki Tetsuka, Osaka-shi (JP)

(73) Assignee: TSUBAKIMOTO CHAIN CO., Osaka-shi, Osaka (JP)

(21) Appl. No.: 15/773,364

(22) PCT Filed: Oct. 31, 2016
(86) PCT No.: PCT/JP2016/082194

§ 371 Date: May 3, 2018

(30) Foreign Application Priority Data
Nov. 16, 2015 (JP) 2015-224191

(51) Int. Cl. F16G 13/16

(52) U.S. Cl. CPC F16G 13/16; H02G 11/00

(57) ABSTRACT

An elongated object guiding device includes a protective guide and a guide rail. The protective guide includes a plurality of links. The links form an accommodation cavity that accommodates an elongated object. The protective guide guides while protecting the elongated object accommodated in the accommodation cavity. The guide rail moves back and forth while guiding the protective guide as the protective guide moves back and forth in a longitudinal direction. The protective guide includes a plurality of engagement portions. The guide rail includes a guide groove that engages the engagement portions and extends in the longitudinal direction to allow the protective guide to be guided. The guide groove restricts movement of the engagement portions in a direction intersecting the longitudinal direction and allows movement of the engagement portions in the longitudinal direction.

### TECHNICAL FIELD

The present invention relates to an elongated object guiding device that guides while protecting an elongated object, such as a flexible cable or hose that supplies power or liquid to a movable unit of a machine tool or the like, when the movable unit moves with the elongated object accommodated in the guiding device and relates to a guide rail included in the guiding device.

### BACKGROUND ART

Patent document 1 describes an energy guiding chain as an example of an elongated object guiding device. The energy guiding chain guides an elongated object, for example, a cable used to transfer energy such as electric energy, and includes a plurality of chain links. Each chain link is formed by two parallel belts and a lateral member that couples the two belts. The energy guiding chain is formed to be elongated by coupling the belts of chain links that are adjacent to each other in a serial direction as joints.

The energy guiding chain is bent at its longitudinally intermediate portion. This forms an upper strip with some of the chain links, a lower strip with the other chain links, and a bent portion that connects the two strips in series. When the energy guiding chain moves, the bent portion moves together with the upper strip.

In this case, the upper strip is placed on the lower strip. Rollers are arranged on the upper strip and the lower strip. The rollers of the upper strip are arranged to roll on a travel surface extending along the opposing chain links of the lower strip when the energy guiding chain moves. The rollers of the lower strip are arranged to roll on a travel surface e extending along the opposing chain links of the upper strip when the energy guiding chain moves.

### PRIOR ART DOCUMENT

### Patent Document

Patent Document 1: Japanese Laid-open Patent Publication No. 2605-48953

### SUMMARY OF THE INVENTION

In the energy guiding chain disclosed in patent document 1, the upper strip is just placed on the lower strip. Thus, when the energy guiding chain moves, the upper strip may be lifted away from the lower strip. As a result, the movement path of the energy guiding chain may be unstable.

It is an object of the present invention to provide an elongated object guiding device and a guide rail that stabilizes a movement, path of a protective guide that guides while protecting an elongated object.

The means for solving the above problem and the advantages of the present invention will now be described.

An elongated object guiding device that solves the above problem includes a protective guide and a guide rail. The protective guide includes a plurality of links that are pivotally coupled to one another in a state arranged in series. The links form an accommodation cavity that accommodates an elongated object. The protective guide guides while protecting the elongated object accommodated in the accommodation cavity. The guide rail moves back and forth while guiding the protective guide as the protective guide moves back and forth in a longitudinal direction while forming a curved portion. The protective guide includes a plurality of engagement portions arranged in the longitudinal direction in a manner allowing for engagement with the guide rail. The guide rail includes a guide groove that engages the engagement portions and extends in the longitudinal direction to allow the protective guide to be guided. When the protective guide moves back and forth, the guide groove restricts movement of the engagement portions in a direction intersecting the longitudinal direction and allows movement of the engagement portions in the longitudinal direction.

In this structure, when the protective guide moves back and forth in the longitudinal direction, the movement of the engagement portions in the direction intersecting the longitudinal direction is restricted by the guide grooves. This stabilizes the movement path of the protective guide that guides while protecting the elongated object.

In the elongated object guiding device, it is preferred that the engagement portions be arranged on at least part of the links and that a gap extend between each of the links and the guide rail.

This structure reduces rubbing of the links, which form the protective guide, against the guide rail when the protective guide and the guide rail move and reduces wear of the links and the guide rail.

In the elongated object guiding device, it is preferred that each of the engagement portions include an arm formed integrally with a corresponding one of the links and an accommodated portion coupled to a distal portion of the arm and accommodated in the guide groove in a movable manner.

In this structure, when the arm is integrally formed with the link, the engagement portion can easily be arranged on the protective guide just by coupling the accommodated portion to the distal portion of the arm.

In the elongated object guiding device, it is preferred that the guide rail be separated, into a plurality of guide rail segments that are coupled to one another in a removable manner.

In this structure, the length of the guide rail can easily be adjusted in accordance with the length of the protective guide.

In the elongated object guiding device, it is preferred that the guide rail and the protective guide move in cooperation and that a movement distance of the guide rail when moved back and forth once be shorter than a movement distance of the protective guide when moved back and forth once.

In this structure, as compared to when the guide rail is moved by a movement mechanism and the protective guide is moved by the movement mechanism, the movement mechanism can be reduced in size.

A guide rail that solves the above problem is included in the elongated object guiding device having the above structure.

This structure has the same advantages as the above elongated object guiding device.

### EFFECT OF THE INVENTION

The present invention stabilizes a movement path of a protective guide that guides while protecting an elongated object.

### BRIEF DESCRIPTION OF THE DRAWINGS

FIG. 1 is a perspective view showing a first embodiment of an elongated object guiding device arranged at a forward limit position.

FIG. 2 is a perspective view showing an engagement link including engagement portions of the first embodiment.

FIG. 3 is a perspective view taken from the opposite side in FIG. 2.

FIG. 4 is a perspective view showing a normal link of the first embodiment.

FIG. 5 is a perspective view taken from the opposite side in FIG. 4.

FIG. 6 is a cross-sectional view showing the engagement link and the normal link of the first embodiment when in a straight arrangement.

FIG. 7 is a cross-sectional view showing the engagement link and the normal link of the first embodiment when in a bent arrangement.

FIG. 8 is a perspective view showing a guide rail of the first embodiment.

FIG. 9 is a front, view showing engagement portions of the engagement link that are engaged with the guide rail in the first embodiment.

FIG. 10 is a perspective view showing the elongated object guiding device of the first embodiment located at a middle position.

FIG. 11 is a perspective view showing the elongated object guiding device of the first embodiment arranged at a backward limit position.

FIG. 12 is a perspective view showing a second embodiment of an elongated object guiding device.

FIG. 13 is a perspective view showing the engagement link including an engagement portion of the second embodiment.

FIG. 14 is a perspective view taken front the opposite side in FIG. 13.

FIG. 15 is an exploded perspective view showing a guide rail of the second embodiment.

FIG. 16 is a front view showing the engagement portion of the engagement link that is engaged with the guide rail in the second embodiment.

FIG. 17 is a perspective view showing an engagement link including an engagement portion of a modified example.

FIG. 18 is a perspective view showing an engagement link including an engagement portion of the modified example.

FIG. 19 is a perspective view showing an elongated object guiding device of the modified example.

FIG. 20 is a perspective view showing an engagement link including an engagement portion of a further modified example,

FIG. 21 is an enlarged cross-sectional view showing the main portion of FIG. 20.

### EMBODIMENTS OF THE INVENTION

### First Embodiment

A first embodiment of an elongated object guiding device will now be described with reference to the drawings.

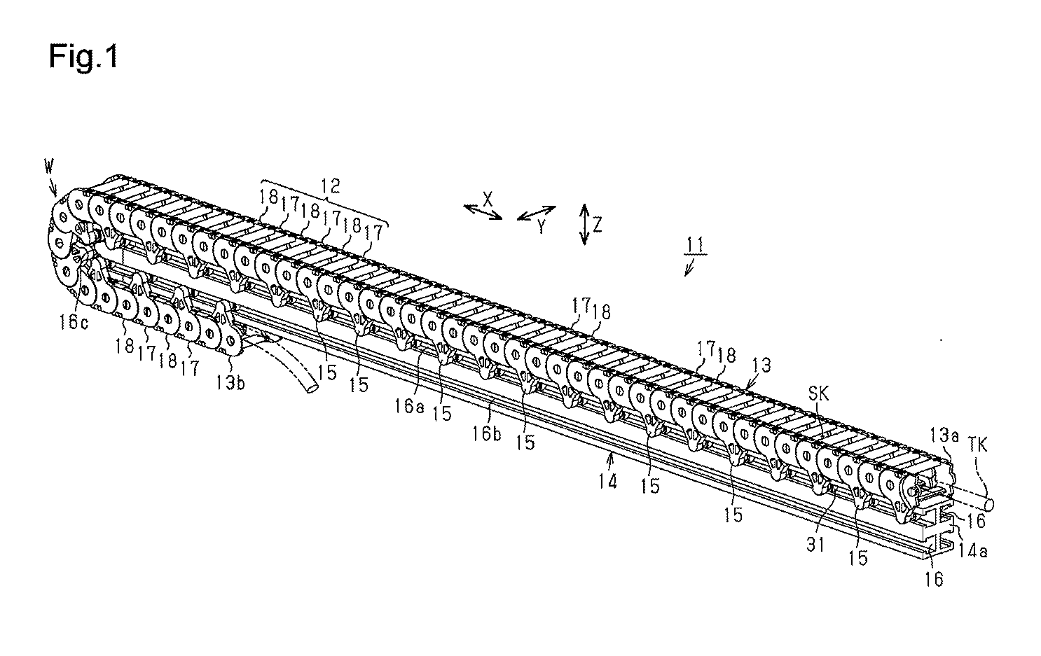

As shown in FIG. 1, an elongated object guiding device 11 includes an elongated protective guide 13. The protective guide 13 includes the protective guide 13 including a plurality of links 12 pivotally coupled to one another in a state arranged in series. The links 12 form an accommodation cavity SK that accommodates an elongated object TK. The protective guide 13 guides while protecting the elongated object TK accommodated in the accommodation cavity SK.

The protective guide 13 is arranged on an apparatus body (not shown), to which the elongated object guiding device 11 is coupled, so as to form a curved portion W at an intermediate part, in this case, a movable body (not shown) that moves back, and forth in a longitudinal direction X is coupled to a first end 13a of the protective guide 13 in the. longitudinal direction X, and a second end 13b of the protective guide 13 in the longitudinal direction X is fixed to the apparatus body (not shown).

Examples of the elongated object TK include an electrical cable or an optical fiber cable that supplies power to the movable body (not shown) and transmits a signal to the movable body (not shown), a hose that supplies gas (for example, air) or liquid (for example, water or oil) to the movable body (not shown), and an elongated multi-joint member that is bendable in a flexible manner.

Further, the elongated object guiding device 11 includes an elongated guide rail 14 that moves back and forth in the longitudinal direction X while guiding the protective guide 13 when the protective guide 13 moves back and forth in the longitudinal direction X while forming the curved portion W at the intermediate part of the protective guide 13. In this case, the curved portion W of the protective guide 13 moves in the longitudinal direction X as the movable body (not shown) moves back and forth in the longitudinal direction X.

The protective guide 13 includes pairs of engagement portions 15 arranged at equal intervals in the longitudinal direction X in a manner allowing for engagement with the guide rail 14. The guide rail 14 includes two guide grooves 16 engaging the pairs of engagement, portions 15 and extending in the longitudinal directions to allow the protective guide 13 to be guided.

The links 12 include a plurality of engagement links 17 and a plurality of normal links 18. Each engagement link 17 is provided with the pair of engagement portions 15, and each normal link 18 is not provided with the engagement portions 15. That is, each engagement link 17 includes the pair of engagement portions 15, and each normal link 18 does not include the engagement portions 15. The protective guide 13 of the present embodiment is formed by pivotally coupling the engagement links 17 and the normal links 18 that are alternate in series in the longitudinal direction X. Accordingly, substantially one half of the links 12 include a pair of engagement portions 15.

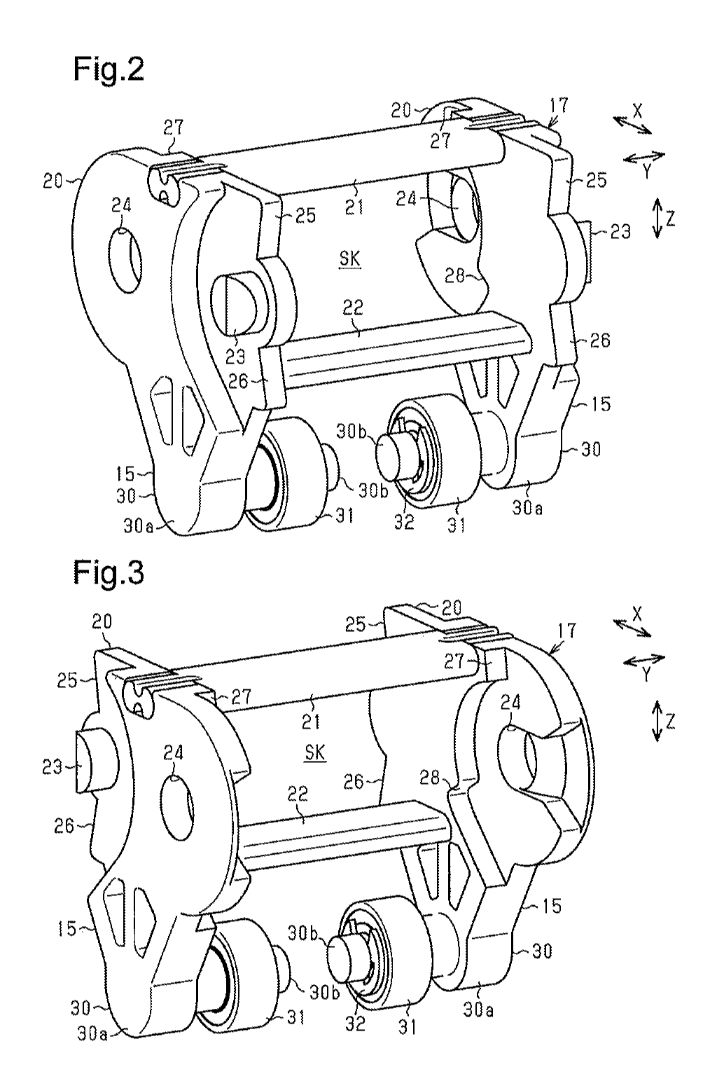

As shown in FIGS. 2 and 3, each engagement link 17, which is formed from, for example, a synthetic resin material, includes two plate-shaped link portions 20 opposing each other in a widthwise direction Y. The widthwise direction Y corresponds to a direction that is orthogonal to the longitudinal direction X. The two link portions 20 are coupled by a first coupling member 21 and a second coupling member 22, which have the form of a rectangular plate, at two sides of the two link portions 20 in a height-wise direction 2. The height-wise direction Z corresponds to a direction that is orthogonal to both the longitudinal direction X and the widthwise direction Y.

In this case, the first coupling member 21 is coupled to the two link portions 20 in a removable manner, and the second coupling member 22 is formed integrally with the two link portions 20. The first coupling member 21 and the second coupling member 22 are opposed to each other in the height-wise direction 2. The space surrounded by the two link portions 20, the first coupling member 21, and the second coupling member 22 form the accommodation cavity SK.

The enter surface of each link portion 20 includes a cylindrical projection 23 located on part of one side of the enter surface in the longitudinal direction X and a circular through hole 24 located in part of the other side of the outer surface in the longitudinal direction X. The projection 23 of another link portion 20 adjacent to the link portion 20 in the longitudinal direction X is fitted into the through hole 24 in a relatively pivotal manner. A first stopper surface 25 is defined on one end surface of each link portion 20 in the longitudinal direction X at a portion that is closer to the first, coupling member 21 than the projection 23, and a second stopper surface 26 is defined on the end surface of the link portion 20 at a portion that is closer to the second coupling member 22 than the projection 23.

A first abutting surface 27 is defined on the middle part, of each link portion 20 in the longitudinal direction X at a portion that is closer to the first coupling member 21 than the through hole 24. The first abutting surface 27 of each link portion 20 can abut against the first stopper surface 25 of another link portion 20 that is adjacent, in the longitudinal direction X. A second abutting surface 28 is defined on the middle part of each link 20 in the longitudinal direction X at a portion that, is closer to the second coupling member 22 than the through hole 24. The second abutting surface 28 of each link portion 20 can abut against the second stopper surface 26 of another link portion 20 that is adjacent in the longitudinal direction X.

The engagement portion 15 is arranged at the end of each link portion 20 that is closer to the second coupling member 22 in the height-wise direction 2. The engagement portion 15 includes an L-shaped arm 30 bent at a right, angle inward in the widthwise direction Y and a roller 31 pivotally coupled to a distal portion of the arm 30. Each of the rollers 31 functions as an accommodated, portion accommodated in the corresponding guide groove 16 (refer to FIG. 1) in a movable manner.

More specifically, the arm 30 includes a support 30a extending from the link portion 20 in the height-wise direction Z and a cylindrical pin 30b extending inward in the widthwise direction Y from an inner end surface of a distal portion of the support 30a. The roller 31 is pivotally supported by a distal portion of the pin 30b. An E-ring 32 that restricts the separation of the roller 31 from the pin 30b is attached to the pin 30b at a position located at the distal side of the roller 31. The arm 30 is formed integrally with, for example, the link portion 20 of the engagement link 17 and integrated with the link portion 20.

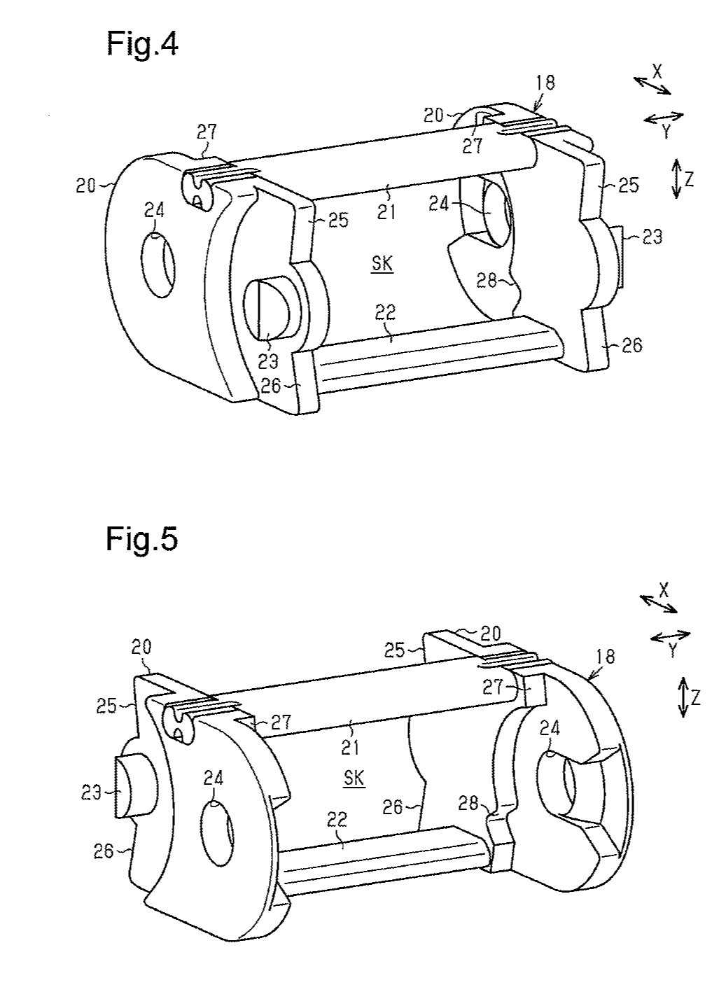

As shown in FIGS. 4 and 5, the normal link 18 is less the engagement portions 15 of the engagement link 17 shown in FIGS. 2 and 3. Thus, in the normal link 18, like or same reference numerals are given to those components that are the same as the corresponding components of the engagement link 17. Such components will not be described.

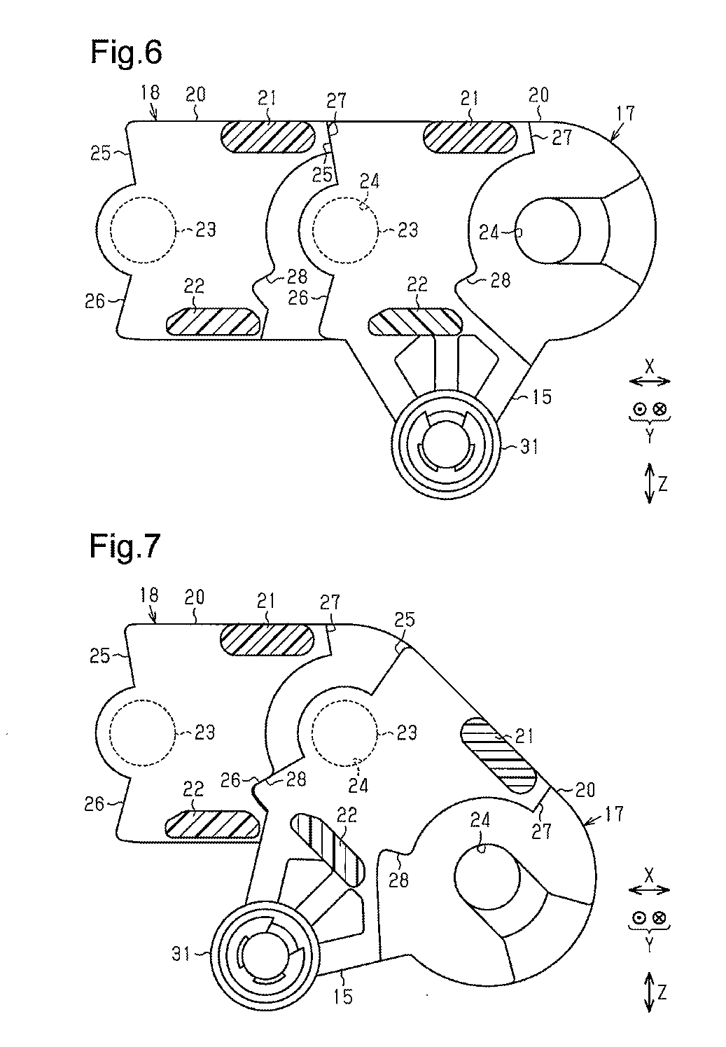

As shown in FIGS. 6 and 7, the engagement link 17 and the normal link 18 that are adjacent in the longitudinal direction X are coupled by pivotally fitting the projection 23 of the link portion 20 of one of the engagement link 17 and the normal link 18 into the through hole 24 of the link portion 20 of the other one of the links. When the engagement link 17 and the normal link 18 are coupled, the link portions 20 of the engagement link 17 and the normal link 18 are pivotal about the through hole 24 and the projection 23 between a straight arrangement in which the engagement link 17 and the normal link 18 are arranged straight as shown in FIG. 6 and a bent arrangement in which the engagement link 17 and the normal link 18 are bent as shown in FIG. 7.

In the present embodiment, the link portions 20 are configured, so that the angle of the link portions 20 of the engagement link 17 and the normal link 18 that are adjacent in the longitudinal direction X when in the straight arrangement is 0 degrees and the angle of the link portions 20 of the engagement link 17 and the normal link 18 that are adjacent in the longitudinal direction X when in the bent arrangement is 30 degrees.

More specifically, when the engagement link 17 and the normal link 18 that are adjacent in the longitudinal direction X are in the straight arrangement as shown in FIG. 6, the first stopper surface 25 of the link portion 20 of one of the engagement link 17 and the normal link 18 is abut against the first abutting surface 27 of the link portion 20 of the other one of the links, and the second stopper surface 26 of the link portion 20 of one of the engagement link 17 and the normal link 18 is moved away from the second abutting surface 28 of the link portion 20 of the other one of the links.

When the engagement link 17 and the normal link 18 that are adjacent in the longitudinal direction X are in the bent arrangement as shown in FIG. 7, the first stopper surface 25 of the link portion 20 of one of the engagement link 17 and the normal link 18 is moved away from the first abutting surface 27 of the link portion 20 of the other one of the links, and the second stopper surface 26 of the link portion 20 of one of the engagement link 17 and the normal link 18 is abut against the second abutting surface 28 of the link portion 20 of the other one of the links.

Thus, abutment of the first stopper surface 25 against the first abutting surface 27 and abutment of the second stopper surface 26 against the second abutting surface 28, in the present embodiment, limit the pivoting range of the engagement link 17 and the normal link 18 that are adjacent in the longitudinal direction X to the angular range of 0 to 30 degrees.

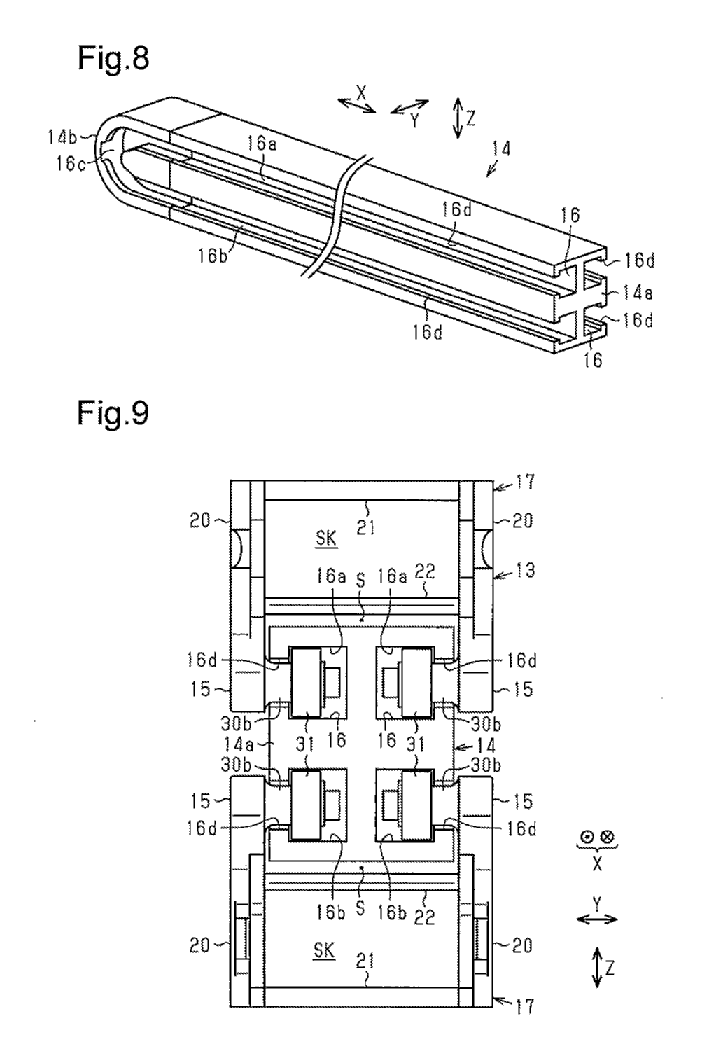

As shown in FIG. 8, the guide rail 14 is substantially box-shaped and elongated in the longitudinal direction X and includes the guide grooves 16 that are formed in two side surfaces of the guide rail 14 in the widthwise direction Y. That is, two guide grooves 16 are respectively formed in the two side surfaces of the guide rail 14 in the widthwise direction Y. The end surface of the guide rail 14 that is closer to a first end of the guide rail 14 in the longitudinal direction X is defined by a flat surface 14a, and the end surface of the guide rail 14 that is closer to a second end of the guide rail 14 in the longitudinal direction X is defined by a curved surface 14b.

As shown in FIG. 8, the guide grooves 16 extend straight from the first end to the second end of the guide rail 14 in the longitudinal direction X and then U-turn to extend straight, to the first end. That is, each of the two guide grooves 16 includes an upper straight portion 16a extending straight from the flat surface 14a toward the curved surface 14b, a lower straight portion 16b located below the upper straight portion 16a and extending straight from the flat surface 14a toward the curved surface 14b, and a U-shaped curved portion 16c that connects the upper straight portion 16a to the lower straight portion 16b at the second end of the guide rail 14 in the longitudinal direction X.

The curved portion 16c is curved along the inner side of the curved surface 14b, and the upper straight portion 16a and the lower straight portion 16b have the same structure. The two guide grooves 16 open in the flat surface 14a of the guide rail 14.

As shown in FIG. 9, the width of the guide rail 14 in the widthwise direction Y is set to be slightly smaller than the distance between the two link portions 20 of the engagement link 17. The guide grooves 16 are set to be wide enough to accommodate the rollers 31 and portions of the pins 30b of the engagement, portions 15 at the distal side of the rollers 31 while including slight play. Openings 16d of the guide grooves 16 in the widthwise direction Y each have a width set to be larger than the outer diameters of portions of the pins 30b of the engagement portions 15 at the basal side of the rollers 31 and smaller than the outer diameters of the rollers 31.

Thus, when the protective guide 13 moves back and forth in the longitudinal direction X, the guide grooves 16 restrict movement of the engagement, portions 15 in a direction intersecting the longitudinal direction X and allows movement of the engagement portions 15 in the longitudinal direction X. That is, when the protective guide 13 moves back and forth in the longitudinal direction X, the guide grooves 16 restrict movement of the engagement portions 15 in a direction other than the direction that is parallel to the guide grooves 16 and allows movement of the engagement portions 15 in the direction parallel to the guide grooves 16.

As shown in FIG. 9, a gap S extends between the guide rail 14 and the engagement link 17 (second coupling member 22). Since the engagement links 17 are coupled to the normal links 18 at the two sides of the normal links 18 in the longitudinal direction X, the gap S also extends between the guide rail 14 and the normal link 18 (second coupling member 22). That is, the gap S extends between the guide rail 14 and the links 12.

The operation of the elongated object guiding device 11 during use will now toe described.

The second end 13b of the protective guide 13 is fixed to the apparatus body (not shown). Thus, when the first end 13a of the protective guide 13 coupled to the movable body (not shown) moves back and forth in the longitudinal direction X together with the movable body, the elongated object guiding device 11 moves back and forth in the longitudinal direction X so that the curved portion W moves in accordance with the movable body.

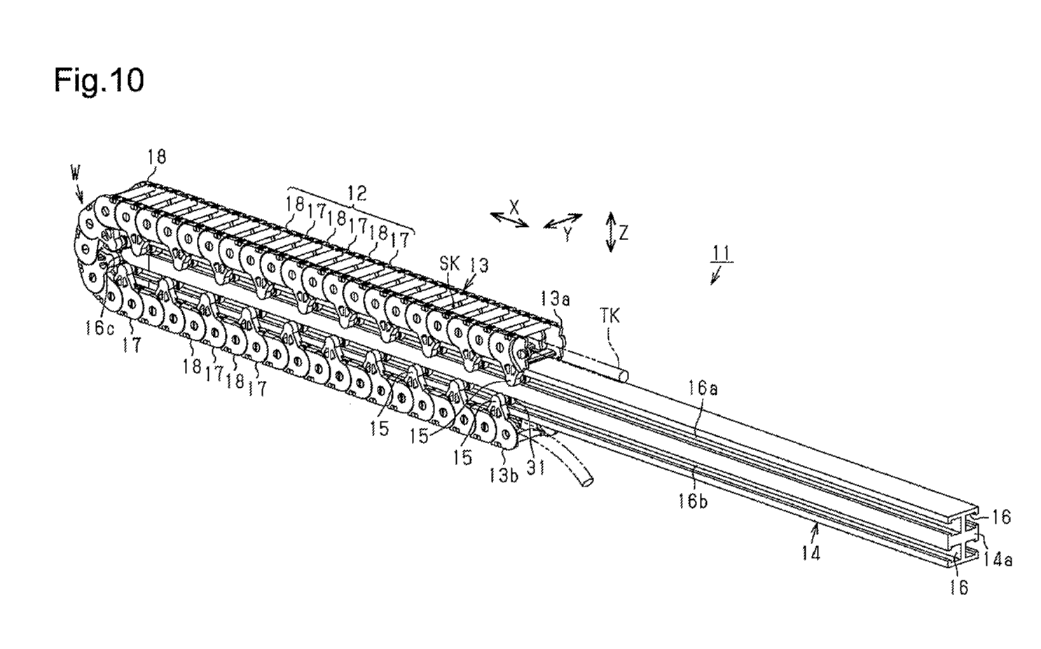

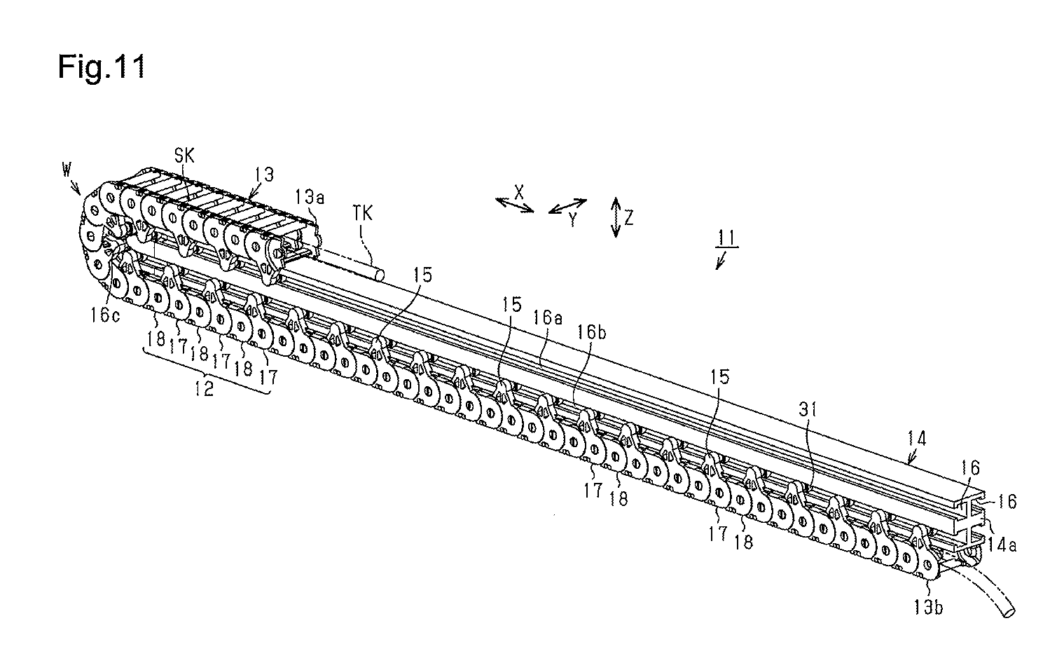

In this case, the elongated object guiding device 11 moves back and forth between a forward limit position where the first end 13a of the protective guide 13 is located at the end of the guide rail 14 that is closer to the flat surface 14a as shown in FIG. 1 and a backward limit position where the second end 13b of the protective guide 13 is located at the end of the guide rail 14 that is closer to the flat surface 14a as shown in FIG. 11. That is, when referring to the position shown in FIG. 10 between the forward limit position and the backward limit position as the middle position, the elongated object guiding device 11 repeatedly moves from the forward limit position via the middle position to the backward limit position and moves from the backward limit position via the middle position to the forward limit position as the movable body (not shown) moves back and forth.

Thus, the elongated object guiding device 11 guides while protecting the elongated object TK, which is accommodated in the accommodation cavity SK, as the movable body (not shown) moves back and forth. In the elongated object guiding device 11, the engagement link 17 and the normal link 18 that are adjacent in the longitudinal direction X are repeatedly pivoted between the straight arrangement shown In Fig, 6 and the bent arrangement shown in FIG. 7 as the curved portion W moves back and forth.

Further, when the elongated object guiding device 11 moves back and forth, the roller 31 of each of the engagement portions 15 of the protective guide 13 rolls inside and along the corresponding guide groove 16. When, the elongated, object guiding device 11 moves from the forward limit position to the backward limit position, the rollers 31 of the engagement portions 15 of the protective guide 13 located on the upper straight portions 16a of the guide grooves 16 are sequentially rolled and moved to the lower straight portions 16b via the curved portions 16c as the protective guide 13 moves when the movable body (not shown) moves.

The rollers 31 located at the curved portion 16c press an outer circumferential surface of the curved portion 16c. Thus, the pressing force of the rollers 31 moves the guide rail 14 toward the backward limit position. That is, the guide rail 14 moves toward the backward limit position as the protective guide 13 moves toward the backward limit position.

When the elongated object guiding device II moves from the backward limit position to the forward limit position, the rollers 31 of the engagement portions 15 of the protective guide 13 located on the lower straight portions 16b of the guide grooves 16 are sequentially rolled and moved to the upper straight portions 16a via the curved portions 16c as the protective guide 13 moves when the movable body (not shown) moves.

The rollers 31 located at the curved portion 16c press an inner circumferential surface of the curved portion 16c. Thus, the pressing force of the rollers 31 moves the guide rail 14 toward the forward limit position. That is, the guide rail 14 moves toward the forward limit position as the protective guide 13 moves toward the forward limit position.

In this manner, since the guide rail 14 moves hack and forth as the protective guide 13 moves back and forth, the guide rail 14 and the protective guide 13 move in cooperation. Further, each engagement portion 15 is engaged with the corresponding guide groove 16 with the protective guide 13 arranged and bent in the U-shape along with the two surfaces of the guide rail 14 in the height-wise direction 2 and along with the curved surface 14b. Thus, when the elongated object guiding device II moves back and forth once between the forward limit position and the backward limit position, the movement distance of the guide rail 14 is approximately half of the movement distance of the protective guide 13. That is, the movement distance of the guide rail when moved back and forth once is shorter than the movement distance of the protective guide 13 when moved back and forth once.

The first embodiment described above in detail has the following advantages.

(1) In the elongated object guiding device 11, when the protective guide 13 moves back and forth, the guide grooves 16 restrict movement of the engagement portions 15 in the direction intersecting the longitudinal direction X and allows movement of the engagement portions 15 in the longitudinal direction X. Thus, when the protective guide 13 moves back and forth in the longitudinal direction X, the movement of the engagement portions 15 in the direction intersecting the longitudinal direction X is restricted by the guide grooves 16. This stabilizes the movement path of the protective guide 13 that guides while protecting the elongated object TK.

(2) In the elongated object guiding device 11, the engagement links 17 includes the engagement portions 15. The gap S extends from each of the engagement links 17 and the normal links 18 to the guide rail 14, that is, between each of the links 12 and the guide rail 14. This reduces rubbing of the links 12, which form the protective guide 13, against the guide rail 14 when the protective guide 13 and the guide rail 14 move and reduces wear of the links 12 and the guide rail 14.

(3) In the elongated object guiding device 11, each engagement portion 15 includes the arm 30, which is arranged integrally with the engagement link 17, and the roller 31, which is coupled to the distal portion of the arm 30 and accommodated in the corresponding guide groove 16 in a movable manner. Thus, when the arm 30 is integrally formed with the engagement link 17, the engagement portion 15 can easily be arranged on the protective guide 13 just, by coupling the roller 31 to the distal portion of the arm 30.

(4) In the elongated object guiding device 11, the guide rail 14 and the protective guide 13 move in cooperation, and the movement, distance of the guide rail 14 when moved back and forth once is shorter than the movement distance of the protective guide 13 when moved back and forth once. Thus, as compared to when the guide rail 14 is moved by a movement mechanism (not shown) and the protective guide 13 is moved by the movement mechanism, the movement, mechanism can be reduced in size. In this case, when the guide rail 14 is moved by the movement mechanism (not shown), the movable body (not shown) is moved together with the protective guide 13.

(5) In the elongated object, guiding device 11, the guide rail 14 supports the protective guide 13. This limits drooping of the protective guide 13 and allows for a longer stroke. Further, since the drooping of the protective guide 13 is limited, deterioration of the product that would result from the drooping of the protective, guide 13 is limited. This increases the service life of the product. In addition, the protective guide 13 is supported by the guide rail 14. This limits situations in which the protective guide 13 is curved and bulged outward by a reaction force of the elongated object TK. This reduces the space occupied by the product and eliminates the need for a member that guides the protective guide 13 in addition to the guide rail 14.

### Second Embodiment

A second embodiment of an elongated object guiding device will now be described with reference to the drawings.

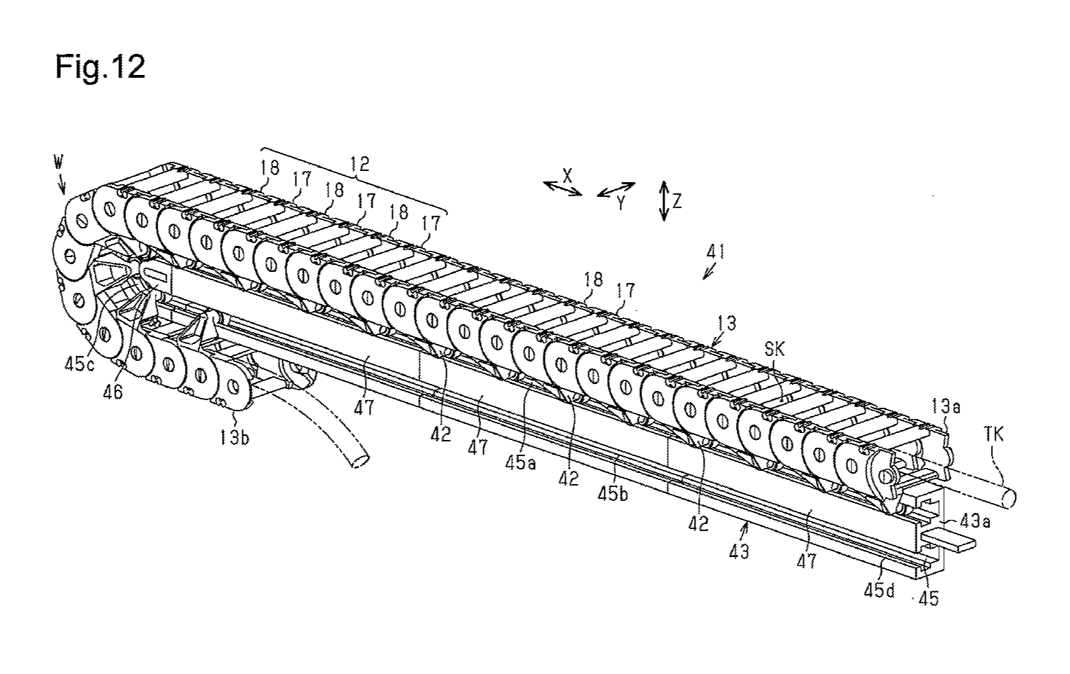

As shown in FIG. 12, an elongated object guiding device 41 of the second embodiment differs from the elongated object guiding device 11 of the first embodiment in that the two engagement portions 15 of each engagement link 17 are changed to a single engagement portion 42 and the guide rail 14 is changed to a guide rail 43. Thus, in the second embodiment, like or same reference numerals are given to those components that are the same as the corresponding components of the first embodiment. Such components will not be described.

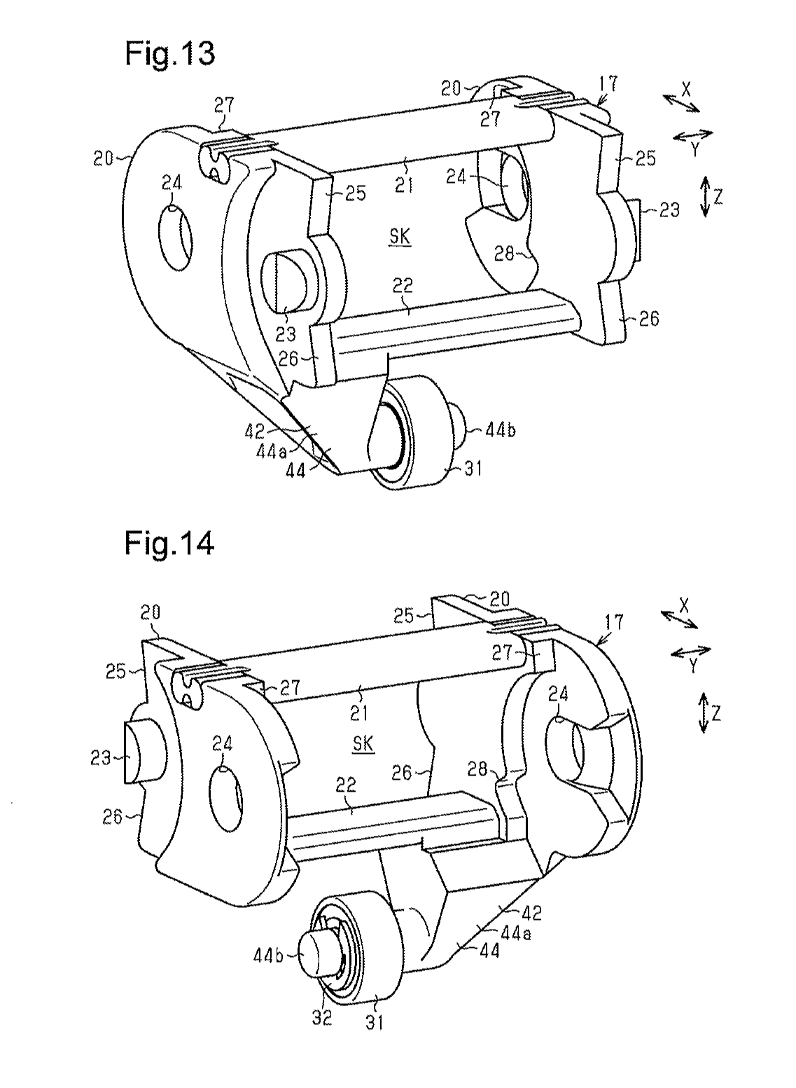

As shown in FIGS. 13 and 14, the engagement portion 42 is arranged at the end of one of the two link portions 20 of the engagement link 17 that is closer to the second coupling member 22 in the height-wise direction Z. The engagement portion 42 includes an L-shaped arm 44 bent inward in the widthwise direction Y and the roller 31 pivotally coupled to a distal portion of the arm 44.

More specifically, the arm 44 includes a support 44a that obliquely extends inward in the widthwise direction Y from the link portion 20 and a cylindrical pin 44b extending inward in the widthwise direction Y from an inner surface of a distal portion of the support 44a. The roller 31 is pivot-ally supported by a distal portion of the pin 44b.

As shown in FIG. 14, the E-ring 32 that limits the separation of the roller 31 from the pin 44b is attached to the pin 44b at a position located at the distal side of the roller 31. In this case, the roller 31 is opposed in the height-wise direction 2 to the middle portion of the engagement link 17 in the widthwise direction Y. The arm 44 is formed integrally with, for example, the link portion 20 of the engagement link 17 and integrated with the link portion 20.

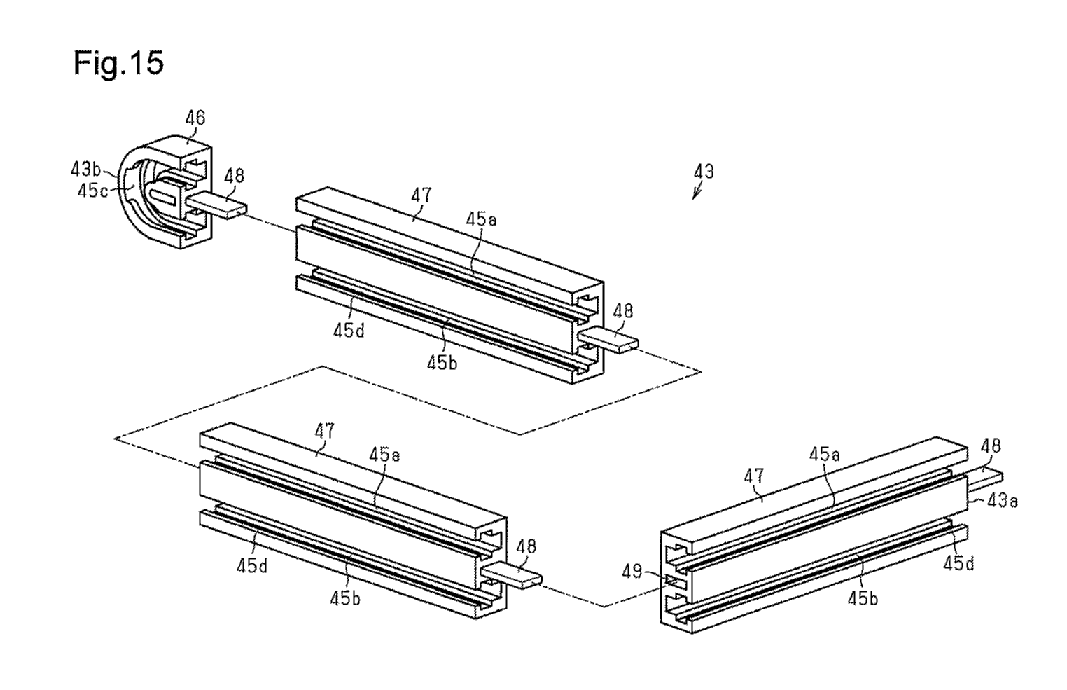

As shown in FIGS. 12 and 15, the guide rail 43 is substantially box-shaped and elongated in the longitudinal direction X and includes a guide groove 45 formed in one of the side surfaces of the guide rail 43 in the widthwise direction Y. The end surface of the guide rail 43 that is closer to a first end of the guide rail 43 in the longitudinal direction X is defined by a flat surface 43a, and the end surface of the guide rail 43 that is closer to a second end of the guide rail 43 in the longitudinal direction X is defined by an arcuate curved surface 43b.

The guide groove 45 extends straight from the first end to the second end of the guide rail 43 and then U-turns to extend straight to the first end. That is, the guide groove 45 includes an upper straight portion 45a extending straight from the flat surface 43a toward the curved surface 43b, a lower straight portion 45b located below the upper straight portion 45a and extending straight from the flat surface 43a toward the curved surface 43b, and a U-shaped curved portion 45c that connects the upper straight portion 45a to the lower straight portion 45b at the second end of the guide rail 14 in the longitudinal direction X.

In this caser the curved portion 45c is curved along the inner side of the curved surface 43b, and the upper straight portion 4 5a and the lower straight portion 45b have the same structure. The guide groove 45 opens in the flat surface 43a of the guide rail 43.

The guide rail 43 is separated into a plurality of guide rail segments that are connected to one another in series in a removable manner. The guide rail segments of the present embodiment include a single first guide rail segment 46 formed by the curved portion 45c and three second guide rail segments 47 including the upper straight portion 45a and the lower straight portion 45b. A rectangular plate-shaped projection piece 48 is formed in a surface of the first guide rail segment 46 at the opposite side of the curved surface 43b.

A projection piece 48 is formed in one end surface of each of the second guide rail segments 47 in the longitudinal direction X, and an insertion hole 49 into which a projection 48 is fitted in a manner allowing for insertion and removal is formed in the other end surface of the second guide rail segment 47 in the longitudinal direction X. The projection piece 48 of the first guide rail segment 46 is fitted into the insertion hole 49 of the first one of the second guide rail segments 47, the projection piece 48 of the first one of the second guide rail segments 47 is fitted into the insertion hole 49 of the second one of the second guide rail segments 47, and the projection piece 48 of the second one of the second guide rail segments 47 is fitted into the insertion hole 49 of the third one of the second guide rail segments 47. In this manner, the guide rail 43 is assembled.

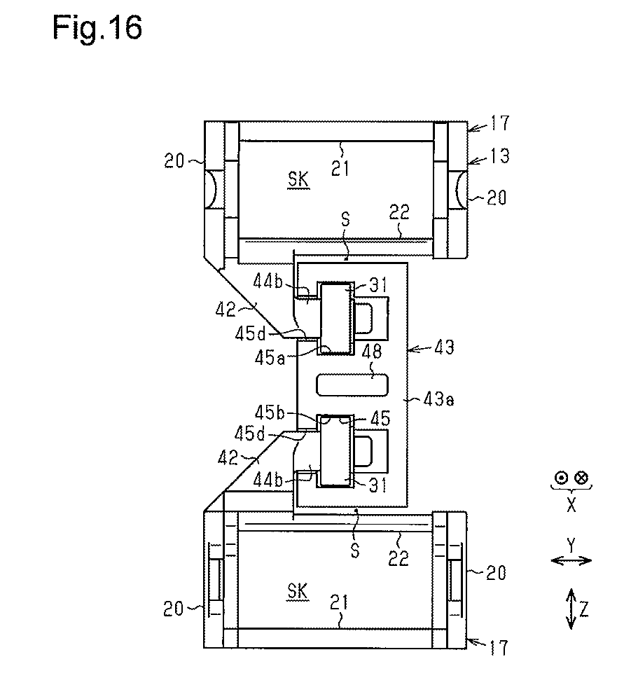

As shown in FIG. 16, the width of the guide rail 43 in the widthwise direction Y is set to be smaller than the distance between the two link portions 20 of the engagement link 17. The guide groove 45 is set to foe wide enough to accommodate the rollers 31 and portions of the pins 44b of the engagement portions 42 at the distal side of the rollers 31 while including slight play. Openings 45d of the guide groove 16 in the widthwise direction Y each have a width set to be larger, than, the outer diameters of portions of the pins 44b of the engagement portions 42 at the basal side of the rollers 31 and smaller than the outer diameters of the rollers 31.

Thus, when the protective guide 13 moves back and forth in the longitudinal direction X, the guide groove 45 restricts movement of the engagement portions 42 in a direction intersecting the longitudinal direction X and allows movement of the engagement portions 42 in the longitudinal direction X. That is, when the protective guide 13 moves back and forth in the longitudinal direction X, the guide groove 45 restricts movement of the engagement portions 42 in a direction other than the direction that is parallel to the guide groove 4 5 and allows movement of the engagement portions 42 in the direction parallel to the guide groove 45.

As shown in FIG. 16, a gap S extends between the guide rail 43 and the engagement link 17 (second coupling member 22). Since the engagement links 17 are coupled to the normal links 18 at the two sides of the normal links 18 in the longitudinal direction X, the gap S also extends between the guide rail 43 and the normal link 18 (second coupling member 22). That is, the gap S extends between the guide rail 43 and the links 12.

The second embodiment described above in detail has the following advantages in addition to advantages (1) to (5).

(6) In the elongated object guiding device 41, the guide rail 43 is separated into the single guide rail segment 46 and the three second guide rail segments 47, which are coupled to one another in a removable manner. Thus, the length of the guide rail 43 can easily be adjusted in accordance with the length of the protective guide 13 just by changing the number of the second guide rail segments 47. That is, the length of the guide rail 43 can easily be adjusted in accordance with, the length of the protective guide 13.

(7) In the elongated object guiding device 41, each engagement link 17 includes only one engagement portion 42. Thus, the number of the rollers 31 that are used is reduced, to half as compared with the elongated object guiding device 11 of the first embodiment.

### Modified Examples

Each of the above embodiments may be modified as described below.

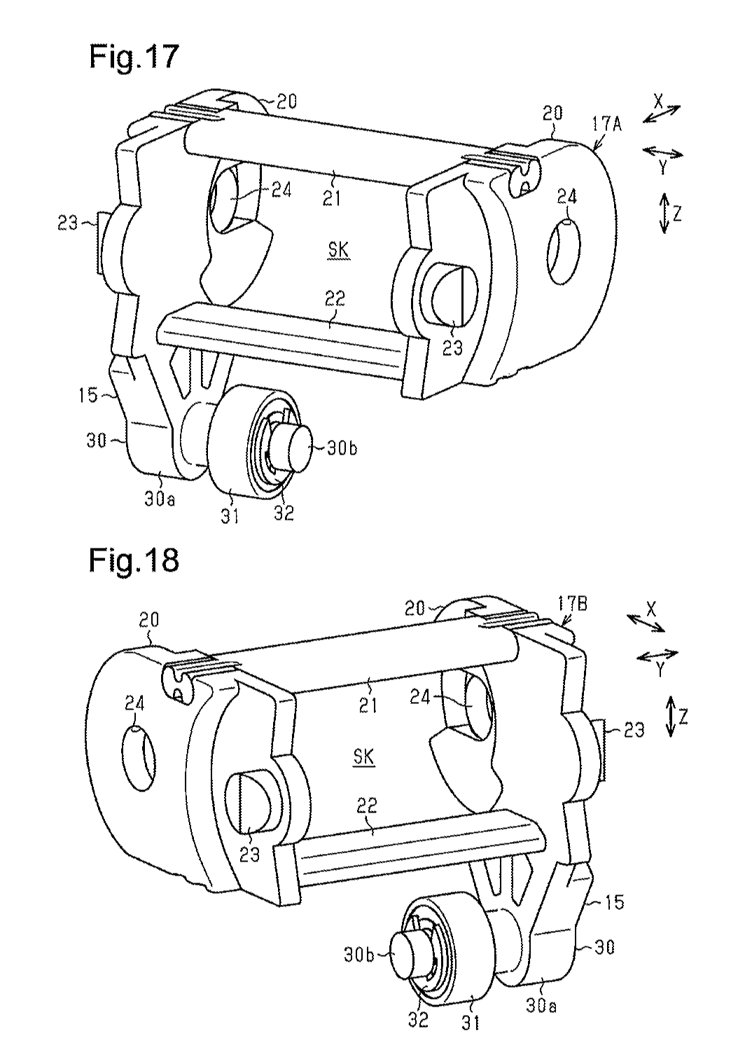

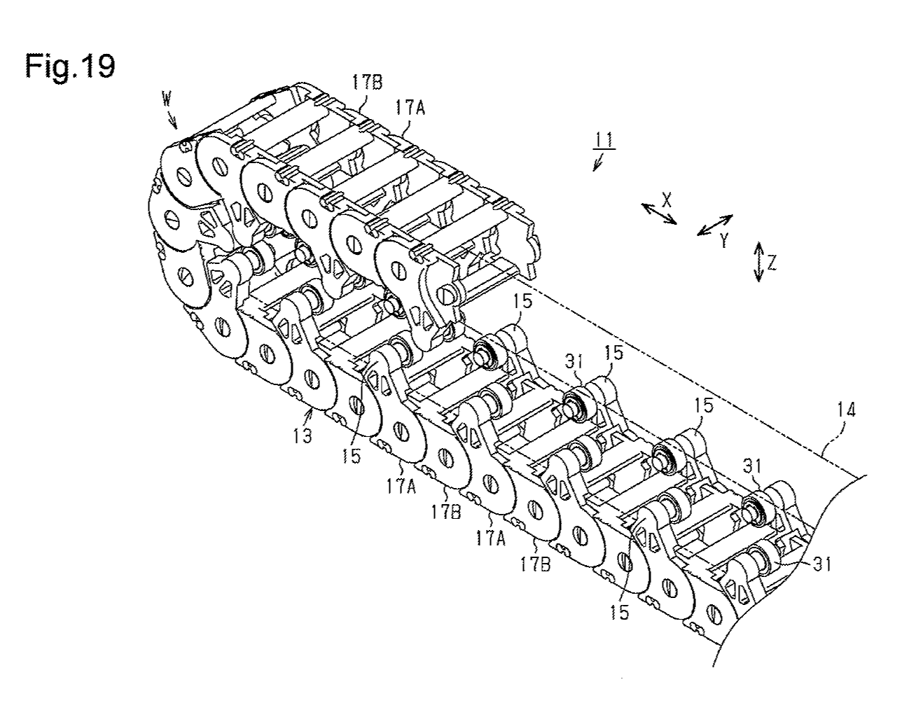

In the elongated object guiding device 11 of the first embodiment, the protective guide 13 may be formed by pivotally coupling an engagement link 17A that does not include one of the engagement portions 15 of each engagement link 17 as shown in FIG. 17 to an engagement link 17B that does not include the other one of the engagement, portions 15 of each engagement link 17 as shown in FIG. 18 with the engagement links 17A and 17B arranged in series. As a result, as shown in FIG. 19, the engagement portions 15 of the protective guide 13 are arranged in a staggered manner in the longitudinal direction X. Thus, the guide rail 14 supports the protective guide 13 in the engagement portions 15 in a well-balanced manner.

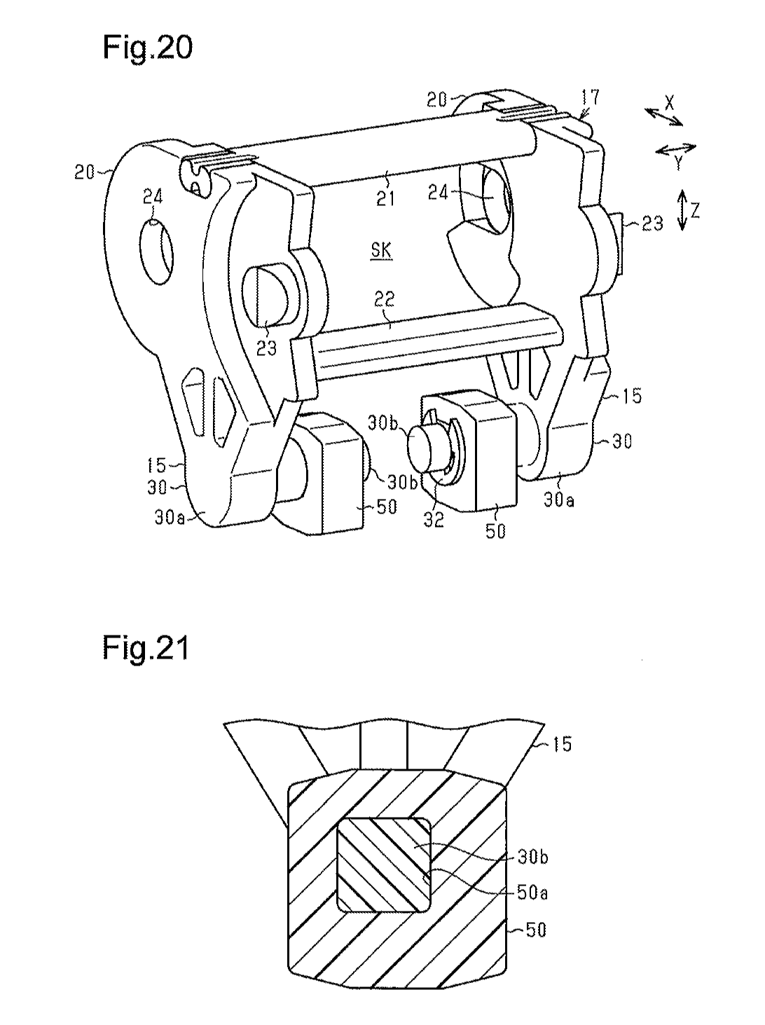

As shown in FIG. 20, instead, of the roller 31 of the engagement portion 15 of the engagement link 17 arranged at the first embodiment, a rectangular sliding member 50 accommodated in the guide groove 16 in a slidable manner may be used as an accommodated portion. In this case, as shown in FIG. 21, the sliding member 50 includes a square through hole 50a located at a position that, is slightly deviated from the center of the sliding member. 50. The cross section of a portion of the pin 30b that supports the sliding member 50 is square in correspondence with the through hole 50a. Thus, when the protective guide 13 moves, the sliding member 50 slides in the guide groove 16 without rotating.

In the first and second embodiments, the pivotal range (for example, −2 to 30 degrees) of the engagement, link 17 and the normal link 18 that are adjacent in the longitudinal direction X may be set to be slightly larger than the pivoting range (for example, 0 to 28 degrees) of the engagement link 17 and the normal link 18 that are adjacent in the longitudinal direction X when the elongated object guiding devices 11 and 41 are used. That is, the protective guide 13 and the guide grooves 16 and 45 may be formed so that when the elongated object guiding devices 11 and 41 are used, the engagement link 17 and the normal link 18 that are adjacent in the longitudinal direction X pivot between a position immediately before being arranged in the straight arrangement and a position immediately before being arranged in the bent arrangement. As a result, when the elongated object guiding devices 11 and 41 are used, the first stopper surface 25 and the second stopper surface 26 of the link portion 20 of one of the engagement link 17 and the normal link 18 that are adjacent in the longitudinal direction X respectively approach the first abutting surface 27 and the second abutting surface 28 of the link portion 20 of the other one of the engagement link 17 and the normal link 18 so that they are close to abutting against each other. This eliminates striking sounds generated when the first stopper surface 25 abuts against the first, abutting surface 27 and when the second stopper surface 26 abuts against the second abutting surface 2.8 during the use of the elongated object guiding devices 11 and 41.

In the first and second embodiments, at least one of the first stopper, surface 25, the first abutting surface 27, the second stopper surface 26, and the second abutting surface 28 of each engagement link 17 and each normal link 18 may be omitted.

The guide rail 14 of the first embodiment may be separated into a plurality of guide rail segments in the same manner as the guide rail 43 of the second embodiment.

In each engagement link 14 and each normal link 18 of the first and second embodiments, the second coupling member 22 may be removable from the two link portions 20.

In the second embodiment, the three second guide rail segments 47 of the guide rail 43 may have different lengths in the longitudinal direction X.

In the second embodiment, the guide rail 43 does not necessarily have to be separated into a plurality of segments.

In the first embodiment, the links 12 forming the protective guide 13 may all include the engagement portions 15. In the second embodiment, the links 12 forming the protective guide 13 may all include the engagement portions 42.

In the first and second embodiments, the protective guide 13 may be constructed so that every third link is the engagement link 17 in the longitudinal direction X or so that every fourth link is the engagement link 17 in the longitudinal direction X. That is, in the protective guide 13, the number of the normal links 18 arranged between the two engagement links 17 located closest from each other in the longitudinal direction X may be two or three.

### DESCRIPTION OF REFERENCE CHARACTERS

11, 41) elongated object guiding device; 12) link; 13) protective guide; 14, 43) guide rail; 15, 42) engagement portion; 16, 45) guide groove; 20) link portion; 30, 44) arm; 31) roller serving as accommodated pout ion; 46) first guide rail segment serving as guide rail segment; 47) second guide rail segment serving as guide rail segment; 50) sliding member serving as accommodated portion; SK) accommodation cavity; TK) elongated object; X) longitudinal direction; W) curved portion

1. An elongated object guiding device comprising:
a protective guide including a plurality of links that are pivotally coupled to one another in a state arranged in series, wherein the links form an accommodation cavity that accommodates an elongated object, and the protective guide guides while protecting the elongated object accommodated in the accommodation cavity; and
a guide rail that moves back and forth while guiding the protective guide as the protective guide moves back and forth in a longitudinal direction while forming a curved portion, wherein
the protective guide includes a plurality of engagement portions arranged in the longitudinal direction in a manner allowing for engagement with the guide rail,
the guide rail includes a guide groove that engages the engagement portions and extends in the longitudinal direction to allow the protective guide to be guided, and
when the protective guide moves back and forth, the guide groove restricts movement of the engagement portions in a direction intersecting the longitudinal direction and allows movement of the engagement portions in the longitudinal direction.

2. The elongated object guiding device according to claim 1, wherein
the engagement portions are arranged on at least part of the links, and
a gap extends between each of the links and the guide rail.

3. The elongated object guiding device according to claim 1, wherein each of the engagement portions includes
an arm formed integrally with a corresponding one of the links, and
an accommodated portion coupled to a distal portion of the arm and accommodated in the guide groove in a movable manner.

4. The elongated object guiding device according to claim 1, wherein the guide rail is separated into a plurality of guide rail segments that are coupled to one another in a removable manner.

5. The elongated object guiding device according to claim 1, wherein
the guide rail and the protective guide move in cooperation, and
a movement distance of the guide rail when moved back and forth once is shorter than a movement distance of the protective guide when moved back and forth once.

6. A guide rail included in the elongated object guiding device according to claim 1.
